(19) United States
(12) Patent Application Publication
(10) Pub. No.: US 2026/0149706 A1
(43) Pub. Date: May 28, 2026

(54) AI-based content monitoring and archiving system.

(71) Applicant: Chad Gordon, Centennial, CO (US)

(72) Inventor: Chad Gordon, Centennial, CO (US)

(73) Assignee: Chad Gordon, Centennial, CO (US)

(21) Appl. No.: 18/958,277

(22) Filed: Nov. 25, 2024

(51) Int. Cl. H04L 9/40; G06Q 30/018

(52) U.S. Cl. CPC H04L 63/08; G06Q 30/018

(57) ABSTRACT

An AI-based employee activity monitoring and archiving system is disclosed herein. The disclosed system utilizes the powers of an AI LLM to monitor live as well as archived content to identify certain patterns and content which may violate some pre-defined organizational rules. The disclosed system consists of six fundamental blocks: The rules block enables the creation and enforcement of new organizational rules to monitor content, the Alerts block enables live monitoring of data during the archiving process to highlight and report certain content which may be identified as violating some rules, the Hub block provides a comprehensive live communication platform allowing users to use the internet while being constantly monitored in real-time, the Information request block provides a front end to screen information access requests and create relevant data repositories to hand over when approved, the Insights block enable analyzing the archived data and create profiles of users, teams etc. based on the content of the stored data, and the discovery and regulatory compliance block allowing law bakers and enforcers to request and monitor data as well as create rules. These six blocks constitute a comprehensive setup allowing real-time as well as archived data screening to highlight and report violations and prevent certain content from going online without approvals.

### FIELD OF INVENTION

Embodiments of the present disclosure generally relate to systems and methods to monitor live and archived employee communications for any unauthorized data transmissions. More precisely, the present disclosure presents a system and a method to monitor and archive real-time employees online, and archived offline, data involving alert generation when certain organizational rules are found to be violated.

### BACKGROUND

Ever since the dawn of modern business ecosystems, employers have shown a key interest in optimal utilization of human capital, official resources, and, most importantly, working hours. Initially, employee on-job activity monitoring was confined to physical observation and sporadic checks on phone usage or basic computer functions. As personal computers became widespread in offices during the 1980s and 1990s, organizations began employing software to track computer usage and productivity. With the rise of the internet, and driven by the necessity to boost productivity, safeguard data, and adhere to regulatory requirements, monitoring expanded to include email surveillance, web browsing logs, and network activity to prevent unauthorized access or data breaches. The early 2000s introduced more advanced systems, such as keyloggers and screen-capturing tools, providing deeper insights into employees'daily activities. As remote work and digital communication tools became more prevalent, particularly during the 2010s, employers started utilizing cloud-based software to monitor activities across various devices and platforms. Today, modern employee monitoring systems incorporate AI and machine learning to analyze user behavior, detect anomalies, and ensure data security, while also grappling with increasing concerns over privacy and ethical boundaries. The balance between managing productivity and respecting employee privacy remains a crucial topic as these systems continue to evolve.

Mandatory archiving laws, in some global jurisdictions, require organizations to systematically preserve records and documents for specific periods, ensuring important information is retained for legal, regulatory, and historical purposes. As a response to data requests from relevant authorities, the archived data is shared after screening and redacting any confidential information as deemed so by the organization. With the exponential increase in the data being generated by every organization, online systems have been deployed by firms to not only monitor the real-time activity of employees, but also ensure the data archiving/recalling process in accordance with the law and the organizational data protection policies.

A look into the existing patent literature provides an insight into the numerous systems, methods and architectures already available for archiving as well as monitoring of the archived/real-time employee data. The analysis further reveals that the existing systems can broadly be classified into two categories namely, (a) Systems for journaling/archiving, and (b) systems for monitoring the real-time employee online activities. The first (a) category of patents includes U.S. Pat. Nos. 9,548,956B2, 9,542,563B2 and US20140280915 which disclose systems involving methods to archive user (employee) data with enhanced data protection using modern encryption techniques. Moreover, the use of blockchain for secure data storage has also been disclosed comprehensively in the prior-art. The aforementioned patents not only involve the archiving/retrieval process but also include screening of the archived data as required by the administrator/user. Amongst the real-time activity monitoring systems (b), patents US20190188804, U.S. Pat. No. 8,601,596B2, US20140379598, U.S. Pat. No. 9,055,097B1, US20140280915, U.S. Pat. No. 11,961,029, US20140214706 and US20220343446 disclose methods of real-time monitoring of user's social media activity. The disclosed inventions also provide means of profiling users based on their online activity and identifying “risky” users who may cause data/confidentiality breaches depending on their social media posts.

The review of the aforementioned prior-art clearly points out the lack of a single comprehensive system to monitor not only the real-time and archived data, but also offline activity including text messages, possibly emails, and phone calls. Additionally, the social media monitoring already disclosed in the prior-art relies only on select social media platforms. Knowing that the employee may communicate using other online methods, a comprehensive real-time assessment system is required. The invention disclosed herein provides a solution to the identified problems in the prior-art by offering a comprehensive online platform provisioning employees to not only access networked applications, but also go about their daily work obligations, whilst being constantly monitored and flagged by an artificial intelligence (AI) based system. Additionally, the disclosed technology also enables vetting of the archived data for specific instances.

### SUMMARY OF THE PRESENT DISCLOSURE

The following presents a simplified summary of features disclosed herein to provide a basic understanding of some exemplary embodiments of the present disclosure. This summary is neither an exclusive overview of all the different embodiments of the present disclosure, nor intended to identify the critical elements of this disclosure. Its sole purpose is to present some concepts disclosed herein in a simplified form as a precursor to a more comprehensive description.

The present disclosure provides a comprehensive system utilizing the powers of AI to monitor and archive employee data for unacceptable user activity. The system is designed specifically to monitor a workplace environment, ensuring the employees do not violate any organizational policies whilst using online platforms (social media, text messaging applications, email etc.).

According to an embodiment of the present disclosure, the workplace data monitoring system may comprise of multiple blocks designed to perform different monitoring tasks ranging from allowing the administrators to create screening rules (the rules block), screening the data to be archived to ensure the set rules are not violated (the alerts block), providing a secure online communications platform for the employees to use web services while being constantly monitored (the hub block), a portal to analyze and vet the archived information requested by other bodies (the information request block), an analysis block to assess individual employee dynamics (the insights block), and an interface to allow area experts (enforcers) to screen data on demand (the discovery and regulatory review block). According to the same embodiment, the system may also allow the administrator to define a limit on what percentage of communication may be reviewed in the system.

According to another embodiment of the present disclosure, the rules block may allow the administrators to define rules which may then be applied to screen and eventually prohibit communication which may become a liability. According to this embodiment, different rule types may be defined which may include rules relating to business specific actions, rules to limit litigation risk, rules regarding physical harm, entity-specific rules, rules regarding cultural norms, and rules related to appropriate linguistic usage.

According to an embodiment, the rules block may also offer a rules library allowing the user to select built-in default rules, in addition to defining their own rules. All the newly defined rules may also be assigned a concern score enabling the organization to mark some statements to be of higher concern allowing for a much sudden immediate action.

According to another embodiment, the alerts block may use AI based large language models (LLMs) to monitor the user communications (content) for any possible rule violations while the archiving process proceeds. The alerts block may trigger any rule violations informing the administrators in real-time while the archiving process continues. Once a violation is identified, the alerts block may create an individual user record within the system containing all the relevant context and data record of the violation. A concern score may also be assigned to every identified rule violation leading to a severity index score aiding the system users to identify serious violations based on the type and frequency of recorded violations.

According to an embodiment, an alerts queue may be created where all the identified alerts along with the severity index may be placed for each identified system user. An administrator may then view each item in the queue marking it either safe or unsafe, helping train the AI LLM on live data. An activity log for every archive may also be created with the complete information on the identified threats and the identification of it in the activity queue. Based on the experience level of the system users, violations with higher severity index may be transferred to a different level of administrators as compared to lower severity threats.

According to yet another embodiment of the present disclosure, in the event of a rule violation, the relevant user may also be notified via, for example, an email of a text message regarding the event. This may cause the identified violating user to directly contact the administrator to explain the specific situation in which the said violation has taken place, allowing the system to take the users'perspective regarding all identified violations.

According to another embodiment, the system may also offer automated data monitoring without the administrator directly verifying each identified threat in the alerts queue. This service may, for example, be offered on a paid subscription basis to desiring customers.

According to yet another embodiment, the alerts block may also offer an analysis subblock to help create reports and charts to observe activity over time.

According to an embodiment of this disclosure, the hub may be a comprehensive communication interface allowing authorized users within the system to use, for example, email, messaging applications, social media, collaboration tools, voice communication applications and video conferencing tools. According to this embodiment, the user may access any of the aforementioned online applications after logging into the system, with the system monitoring all user activity using AI (LLM) for any rule violations.

According to an embodiment, the hub may allow online access to users using a single front end where users may access all their communications platforms whilst being monitored for any violations on the fly. According to the same embodiment, the user may connect any number of communication channels to their account populating a feed list allowing the user to designate the channels which they would like to be notified about when any unread activity takes place.

According to an embodiment, whilst communicating through the already identified communications channels within the hub, all messages may be screened for rule violations and flagged into, for example, yellow and red flags. The yellow flag may be raised for warnings regarding violations identified as low severity, whereas the red flag may be raised for serious rule violations and may also be reported to the administrators. All the red flagged communication may be temporarily blocked by the hub, until, for example, the user changes the text. According to the same embodiment, the LLM may also offer system generated, acceptable text, as an alternative for the user to use. The system may also detect rephrasing, euphemism, disguising words with the text while assuring all rule violations are highlighted.

According to an embodiment, hub may also notify the users of how a certain communication, for example, a social media post may violate the rules. The users may also be allowed to schedule social media posting in advance, and also direct the AI (LLM) to generate text in accordance with the organizational rules concerning a certain topic as identified by the user.

According to another embodiment, data monitoring and report generation may also be provided allowing the administrators to monitor the entire activity of all users based on the number of identified posts and other metrics as required by the administrators.

According to another embodiment, the information request block may enable the organization to screen and vet the archived data as a response to mandatory information requests generated by government authorities. According to the same embodiment, requesting parties may directly generate a request through, for example, a webpage for any information they would like the organization to disclose from the past.

According to an embodiment, the information request may include the requestor's details, the time duration for which the data is required, and the keywords which are to be included in the required data. The information request block may perform a preliminary search and may also notify the requester about the amount of data recovered in accordance with the information request. The requester may then add further filters to limit or expand the search. Once the query is finalized the information request block may generate an automated request letter which may serve as an official information access request signed by both the organization and the requester.

According to another embodiment, the information request block may process the finalized user data request by collecting all information and suggesting redactions and placing these into a request queue. According to the same embodiment, any administrating user of the information request block may visit the queue, review the redactions and either confirm or reject them to finalize the response to be provided to the requestor. The system may also allow access to already closed requests along with the details which were included in each request.

According to yet another embodiment of the present disclosure, the insights block may offer the organization the chance to view the dynamics of their personnel, teams, company and clients. Reports may include client sentiment, team insights, communication style suggestions, personal employee insights and organizations insights. According to the same embodiment, client sentiment may include factors like complaints, job satisfaction, frustration, stress, account transfer risk, life changes and alternate opportunities. Team insights may provide detailed overview of the individual team members who are engaged and productive, leadership and decision execution details, communication clarity etc. The team insights may also provide system generated suggestions on which team members would be ideal for a certain team to accomplish a given task, based on the aforementioned insights. Additionally, the insights tool may also provide automatically generated suggestions on the choice of wording, style of communications and the level of detail suitable for a certain communication type. The individual and company insights of would provide assessment on every employee based on their communication activity, and also give a general overview of the company's performance in terms of culture and work ethics based on the assessments.

According to one final embodiment, the discovery and regulatory review block is provided which may allow enforcers the ability to archive communications. The enforcers may include, for example, lawyers, journalists and media organizations. This block may enable enforcers to monitor for any rule violations on the data not present on the system but uploaded specifically by the enforcer for screening purposes. According to the same embodiment, the enforcer may either select existing rules from the rules library or create their own rules to be applicable on the data to be screened. This block may help train the AI (LLM) by providing better insights into rule violations, since the enforcers are the once most educated about the laws.

The combination of the six blocks provides a comprehensive system which, when applied to mandatory communication archiving, addresses the heart of why rules, regulations and laws exist. The system provides a platform to not only store data for future proof of events, but also enables automated screening of communications for rule violations, and to also address direct data disclosure requests.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The above-mentioned and other features of this disclosure, and the manner of attaining them, will become more apparent by reference to the following description of embodiments taken in conjunction with the accompanying drawings, wherein:

FIG. 1 shows the complete block diagram of disclosed AI-based content archiving and monitoring system.

FIG. 2 shows the functional block diagram of the rules block;

FIG. 3 shows the block diagram of the alerts block;

FIG. 4 shows the flow chart depicting the operation of the hub block;

FIG. 5 shows the clow chart depicting the operation of the information request block;

FIG. 6 shows the block diagram of the discovery and regulatory review block; and

FIG. 7 SHOWS THE BLOCK DIAGRAM OF THE INSIGHTS BLOCK.

Corresponding reference numerals indicate corresponding parts throughout the figures. The exemplifications set herein illustrate merely the embodiments of the disclosure and such exemplifications are not to be construed as limiting the scope of the present disclosure in any manner.

### DETAILED DESCRIPTION

Embodiments of the present disclosure will now be described more fully hereinafter with reference to the accompanying drawings, in which some, but not all embodiments of the disclosure are shown. The present disclosure will be better understood with reference to the definitions, examples and descriptions provided herein.

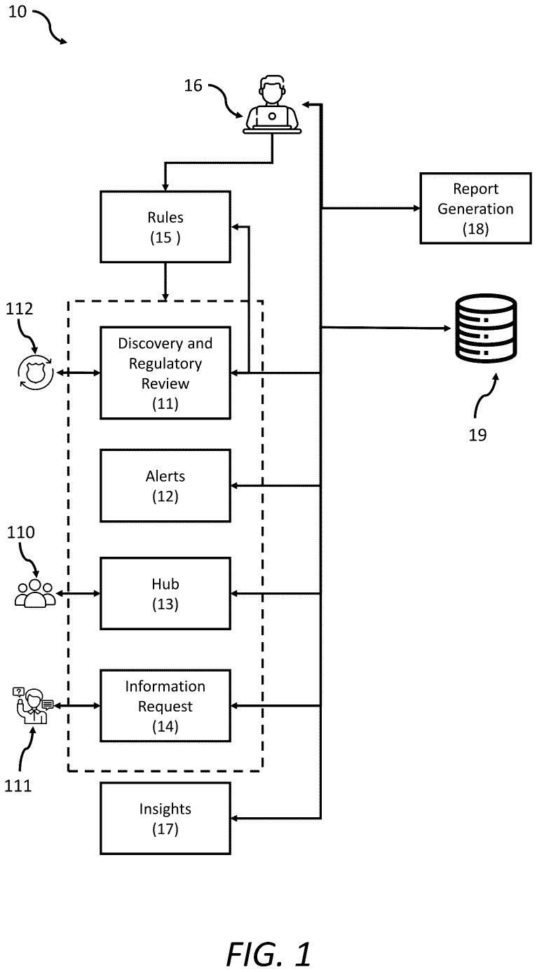

FIG. 1 shows a block level view 10 of the disclosed AI-based content archiving and monitoring system. The system 10 consists of four functional blocks namely discovery and regulatory review block 11, alerts block 12, hub block 13, and the information request block 14 as shown in FIG. 1. A rules block 15 enables the system administrator 16 to select and/or define the data screening rules applicable to all the aforementioned four functional blocks. Two additional blocks, namely insights 17 and report generation 18, are also included to provide statistics and generate custom designed analysis and reports based on the performance of the four functional blocks. The entire system 10 has access to database 19 which is used to archive the required data as and when directed by any of the four functional blocks.

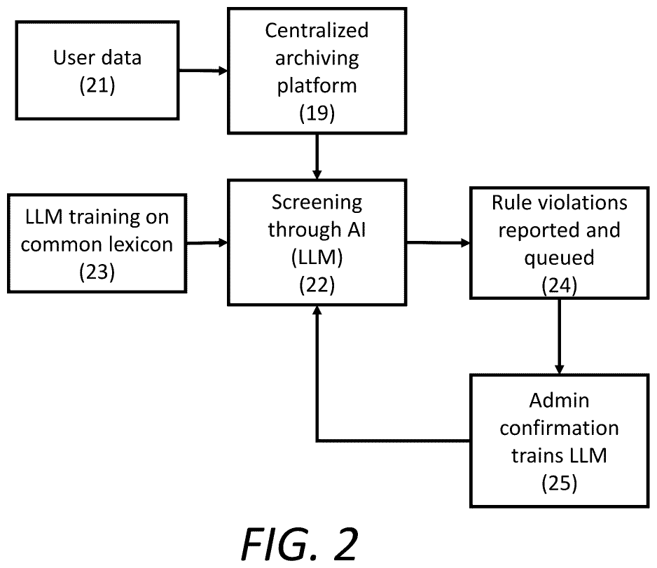

FIG. 2 shows the block diagram of the rules block 15. This block gathers user data 21 for archiving into database 19. An AI LLM system 22 vets the user data 21 while the archiving process continues. The AI LLM system 22 is trained initially using a common violating lexicon library 23, with predefined violation rules defined by the administrator 16. Additionally, any user data 21 found to be violating due to the usage of specific terms as defined in the violating lexicon library 23 is highlighted and added into a rule violations queue 24. Administrator 16 manually checks each entry in the rule violations queue 24 and either confirms or rejects violation 25. The administrator's 16 response to the rule violations queue 24 entries is then further utilized to train the AI LLM. Administrator 16 has the right to select specific rules from the lexicon library 23 and enforce them any of the four functional blocks as required.

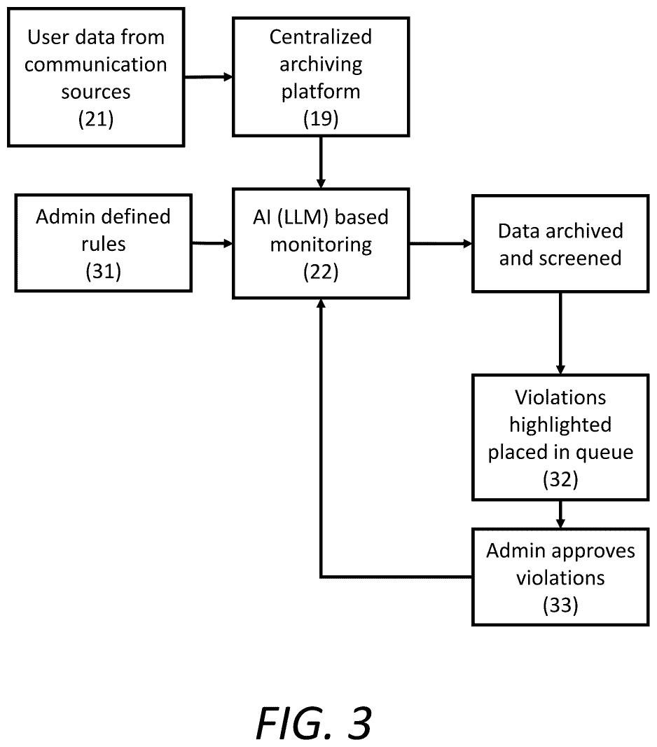

FIG. 3 shows the block diagram of the alerts block 12. This block deals mainly with violation detection and reporting while archiving the user data 21 gathered from multiple sources. Whilst the data is being archived into database 19, the AI LLM system 22 continuously monitors the user data 21 for any violations of the rules 31 as defined by the rules block 15. Any detected violations are highlighted and placed in a queue 32 for the administrator's approval 33. Consequently alerts (email or text messages) are also generated to notify the administrator 16 of new entries into the violations queue 32. The AI LLM system 22 may also autonomously highlight violations without the requirement of the administrator's approval 33. All the violations are also recorded in an activity log kept within the alerts system for every individual user for which the data is being archived.

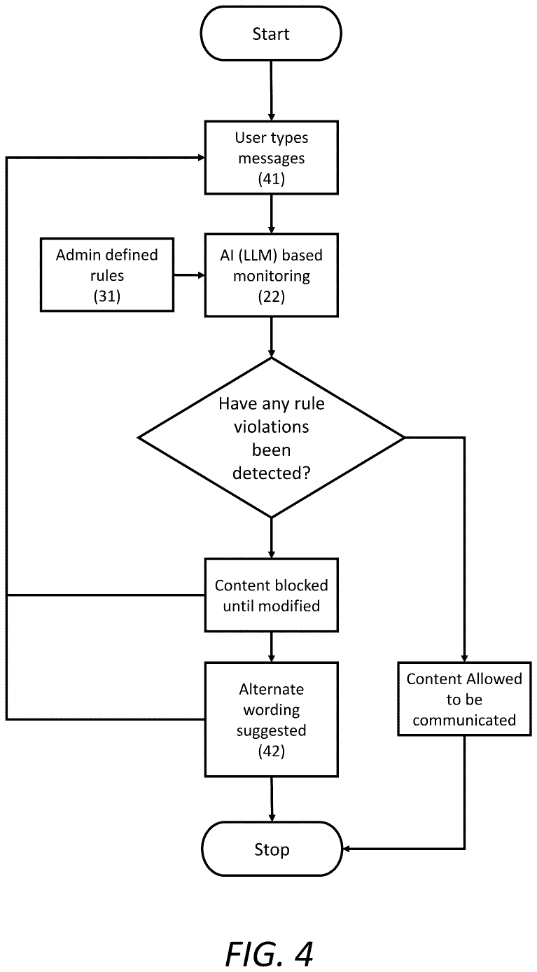

FIG. 4 shows a flow chart detailing the operation of the hub block 13. Individual users 110 (FIG. 1) access the hub block 13 through dedicated login credentials where online access is provided to every user 110. Any message/text 41 the user 110 types while logged in to the hub block 13 is monitored by the AI LLM system 22 for possible violations against the rules 31 as enforced by the administrator 16. If the AI LLM system 22 highlights any rule violations, the user 110 is blocked to sharing the violating text 41 until it is modified by the user and is cleared by the AI LLM system 22 as safe. Alternatively, automated replies 42 which are safe, are also suggested to the user 110 to use instead of the violating text 41.

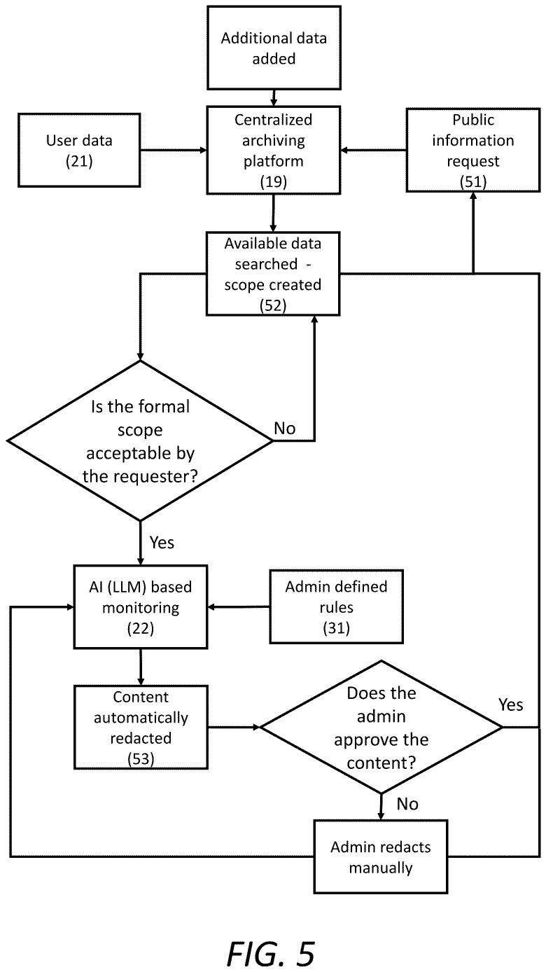

FIG. 5 shows the operational flow chart for the information request block 14. The information request block 14 enables outside entities to submit requests to access archived data under freedom of information act (or similar) laws. The requestor 111 accesses the webpage of the system and lodges a public information request 51 detailing the type of data (keywords), the time duration etc. for the requested data. The initial public information request 51 is analyzed by the AI LLM system 22 and a scope 52 is created which provides a summary of the data found fulfilling the public information request 51 specifications. This scope 52 is provided to the requestor 111 to verify and confirm before the data retrieval process proceeds. Once the scope 51 is accepted, the Al LLM system 22 analyzes the retrieved user data in accordance with the applicable rules 31 and redacts any data parts according to the relevant rules 31. The finalized data file 53 (with the redactions), once approved by the administrator 16, is shared with the requestor 111 though the system webpage.

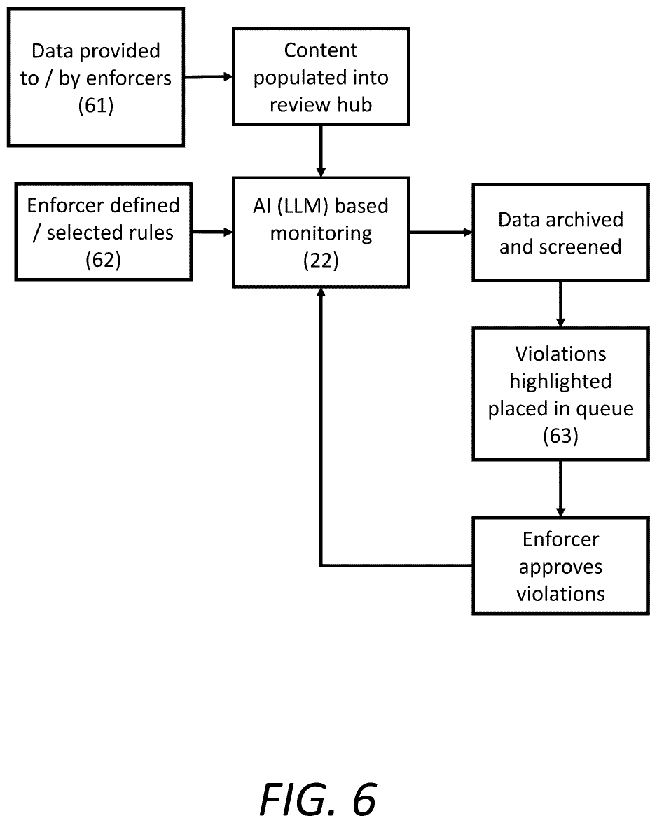

FIG. 6 shows the block diagram of the discovery and regulatory review block 11. This block enables enforcers 112 who may be journalists, lawyers or other law enforcement agencies to not only request and vet the archived records, but to also upload their own data 61 and use the AI LLM system 22 to identify any rule violations in the context of specific cases. This block also allows the enforcers 112 to define/create their own rules 62 in addition to the rules already available in the rules block 15. The newly created rules 62 are then checked for by the AI LLM system 22 to highlight any violations in the uploaded data 61. Any highlighted violations are placed in a queue 63 and the enforcer 112 is notified to verify the highlighted violations. Upon finalization by the enforcer 112, a data log is created stored within the discovery and regulatory review block 11.

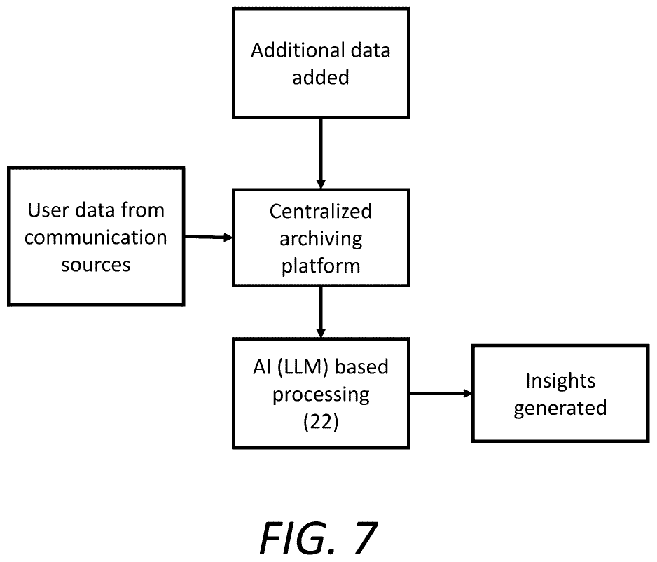

The functional block diagram of the insights block 17 is shown in FIG. 7. Based on the data archived and monitored, this block 17 generated overall statistics on the team performance, provides suggestions for common communication usage and gives an overview of the general organizational communication/content based on the detailed AI LLM system 22 analysis.

All the four functional blocks of the system 10 of FIG. 1 are connected to the report generation 18 block. This block offers the administrator 16 the rights to generate reports, charts and other statistics on the analysis of each of the four functional blocks of the system 10. These reports and statistics can then be shared across the organization for analysis.

As is evident from the description, numerous adjustments and alterations can be made to the disclosed embodiments. It should be noted that the multiple embodiments of the present disclosure, disclosed herein, may be implemented differently from the specific description provided herein, as long as the said implementation falls within the boundaries defined by the following claims:

1. An AI-based content archiving and monitoring system comprising mainly of:
a rules block;
an alerts block;
a hub block;
an information request block;
a discovery and regulatory compliance block;
an insights block;
a reporting block; and
a database.

2. The AI-based content archiving and monitoring system of claim 1, wherein the rules block further comprises of a host with at least a processor, a memory, and a plurality of programming instructions stored in the memory and operating on the processor, wherein the programmable instructions, when operating on the processor, cause the processor to:
provide an interface for an administrative user or a user with adequate privileges to define at least one violation rule;
store the defined violation rule in the database; and
provide an interface for an administrative user or a user with adequate privileges to select at least one violation rule from a list of available violation rules to be enforced.

3. The AI-based content archiving and monitoring system of claim 1 wherein all the blocks are connected to the database through a network.

4. The AI-based content archiving and monitoring system of claim 1, wherein the alerts block further comprises of a host with at least a processor, a memory, and a plurality of programming instructions including AI LLM instructions stored in the memory and operating on the processor, wherein the programmable instructions, when operating on the processor, cause the processor to:
initiate data archiving for users as nominated by an administrative user or a user with adequate privileges;
screen the data being archived against at least one violation rule as selected by an administrative user or a user with adequate privileges;
utilize AI LLM computer instructions to detect and highlight rule violations in the data being archived; and
generate a log of the entire screening process.

5. The AI-based content archiving and monitoring system of claim 1, wherein the hub block further comprises of:
a user interface allowing authorized users to access online services using proper login credentials;
a set of at least one violation rule assigned to the individual user by an administrative user or a user with adequate privileges;
the ability to real-time monitor the user typed content for any rule violations using a set of preprogrammed AI LLM computer instructions; and
blocking the user typed content from being posted if screened to be violating the assigned rules.

6. The AI-based content archiving and monitoring system of claim 5, wherein
the user typed content is blocked after being reviewed by an administrative user or a user with adequate privileges; and
the user typed content is blocked immediately after being screened by the AI LLM computer instructions.

7. The AI-based content archiving and monitoring system of claim 1, wherein the information request block further comprises of:
a requester generating a public information request through a dedicated web interface;
AI LLM computer instructions reviewing the request and creating an initial scope of search;
recovering the relevant data from the database in accordance with the scope of the search;
redacting parts of the recovered data in accordance with the rules as assigned by an administrative user or a user with adequate privileges; and
delivering the final data to the requester.

8. The AI-based content archiving and monitoring system of claim 7 wherein the initial scope includes:
search keywords;
search phrases;
user credentials;
calendar dates; and
time stamps.

9. The AI-based content archiving and monitoring system of claim 7 wherein data redaction is done using AI LLM computer instructions.

10. The AI-based content archiving and monitoring system of claim 7 wherein data redaction is approved by an administrative user or a user with adequate privileges.

11. The AI-based content archiving and monitoring system of claim 1, wherein the discovery and regulatory compliance block further comprises of:
a user interface for the enforcer to upload necessary data for compliance checking;
a rule selection processes allowing the enforcer to select at least one relevant rule;
a set of AI LLM computer instructions to screen the uploaded data against the selected rules to highlight any rule violations; and
an activity log generation process to generate an activity log of the process.

12. The AI-based content archiving and monitoring system of claim 11, wherein the user can create at least one custom rule for the search.

13. The AI-based content archiving and monitoring system of claim 11, wherein the user can select at least one rule from a list of predefined rules.

14. The AI-based content archiving and monitoring system of claim 1, wherein the insights block provides
team insights based on the screened data;
individual user insights based on the screened data; and
suggestions on appropriate linguistic additions in line with the rules.

15. The AI-based content archiving and monitoring system of claim 1 wherein the reporting block comprises of:
an interface to allow an administrative user or a user with adequate privileges to select activity log collection from different blocks;
an analysis interface to present the activity log data in different visual representations as required by an administrative user or a user with adequate privileges;
an interface to select the parameters to be included in the final report; and
a transmission block to communicate the generated report as instructed by an administrative user or a user with adequate privileges.

16. A method of AI-based content archiving and monitoring comprising the steps of:
collecting user data to be screened;
selecting at least one violation rule from the rules block;
passing the collected user data to an AI LLM computer instruction to screen the user data for rule violations;
highlighting the violation instances within the user data; and
undertaking appropriate action.

17. The AI-based content archiving and monitoring method of claim 16, wherein the user data is retrieved from a database.

18. The AI-based content archiving and monitoring method of claim 16, wherein the user data is collected from real-time user activity.

19. The AI-based content archiving and monitoring method of claim 16, wherein the appropriate action comprises of:
blocking the violated content;
alerting an administrative user or a user with adequate privileges of the said violation; and
logging the details of the violation in an activity log.
